(19) United States
(12) Patent Application Publication
(10) Pub. No.: US 2018/0176737 A1
(43) Pub. Date: Jun. 21, 2018

(54) SYSTEM AND METHOD FOR DETERMINING LOCATION OF MOBILE DEVICES

(71) Applicant: Qubercomm Technologies, Inc., Walnut, CA (US)

(72) Inventors: Sundar SUBRAMANIYAN, Chennai (IN); Senthil Kumar BALASUBRAMANIAN, Chennai (IN); Sudarsan VASUDEVAN, Chennai (IN)

(21) Appl. No.: 15/630,910

(22) Filed: Jun. 22, 2017

(30) Foreign Application Priority Data
Dec. 20, 2016 (IN) 201621043529

(51) Int. Cl. H04W 4/02; H04L 29/08; H04W 4/20; H04W 92/18; G06F 21/88

(52) U.S. Cl. CPC H04W 4/025; H04W 4/023; H04L 67/26; G06F 2221/2111; H04W 92/18; H04L 67/306; G06F 21/88; H04W 4/206

(57) ABSTRACT

Method and a system for determining distance between a mobile device and a beacon device have been disclosed. Primary beacons and secondary beacons are received by a mobile device, from a beacon device. The mobile device extracts value of transmission power for each of the secondary beacons from identifier data associated with the secondary beacons. Based on the value of transmission power, an average distance between the mobile device and the beacon device is then generated. Based on the average distance and a power lookup data, an optimal value of transmission power is identified from different values of transmission power. An actual distance between the mobile device and the beacon device is computed based on the optimal value of transmission power. The actual distance is then utilized to determine a location of the mobile device.

### CROSS REFERENCE TO RELATED APPLICATIONS AND PRIORITY

The present application claims priority from Indian Patent Application No. 201621043529 filed on 20 Dec. 2016 the entirety of which is hereby incorporated by reference.

### TECHNICAL FIELD

The present disclosure in general relates to the location detection. More particularly, the present disclosure relates to a system and method for determining location of a mobile device using beacons.

### BACKGROUND

Positioning systems, such as Geo-location devices, determine position of a device in various scenarios. For example, for a GPS enabled mobile device, location of the mobile device may be plotted on a map. In another example, the mobile device may receive location information such as current geometrical coordinates, traffic updates, nearby places, etc. by enabling the GPS. Location services have thus become an important part of mobile communications.

Generally, positioning systems meant for outdoor locations do not work accurately for indoors. One of the many reasons for this is a lack of GPS signal strength in indoors. Further, an indoor location, such as a mall, may not always provide mobile users free Wi-Fi access thus restricting indoor navigation for the user's mobile device. A conventional solution for indoor navigation is using beacons for activating an application on the user's mobile device, and sending wireless signals from these beacons to the mobile device, typically using Bluetooth Low Energy (BLE) technology. Based on these signals, the location of the mobile device may be determined with respect to the beacon device. However, the location accuracy in such setups estimated by the mobile applications are strictly limited by what is offered by the mobile operating system frameworks when using standard beacons. Also, because some mobile operating systems may not allow the beacon frames to be inspected for reading low-level details of the beacons such as reference transmit power level, which may be detrimental in accurate determination of location of the mobile device by the mobile application.

Another challenge with indoor location detection using beacons is reliance of the mobile application on the operating system framework's ability to provide approximation of distances between the mobile device and one or more beacon devices. The framework may not pass the beacon frames of every beacon received up to the application layer. Further, passing of information about every received beacon in such systems may be as slow as 1 second. This may in turn cause latency in calculations. Since, distance estimations between the mobile device and beacon devices play a crucial role in determination of the current location of the mobile device, such latencies and miscalculations may result in inaccuracies.

### SUMMARY

This summary is provided to introduce aspects related to system and method for facilitating maintenance of an equipment, further described below in the detailed description. This summary is not intended to identify essential features of the claimed subject matter nor is it intended for use in determining or limiting the scope of the claimed subject matter.

In one implementation, a method for determining distance between a mobile device and a beacon device is disclosed. The method includes receiving, by a processor, from a beacon device, primary beacons and secondary beacons alternatively for a predefined period of time. The secondary beacons are transmitted at varying transmission powers. The method further comprises extracting, by the processor, a value of transmission power from identifier data associated with each of the secondary beacons. The method further comprises determining, by the processor, for each of the secondary beacons, an average distance between the mobile device and the beacon device based the value of transmission power. The method further comprises, identifying, by the processor, an optimal value of transmission power based on the average distance and a power lookup table. The method further comprises computing, by the processor, an actual distance between the mobile device and the beacon device based on the optimal value of transmission power.

In another implementation, a system for determining distance between a mobile device and a beacon device is disclosed. The system comprises a memory and a processor coupled to the memory, wherein the processor is configured to execute instructions stored in the memory to receive primary beacons and secondary beacons from a beacon device alternatively for a predefined time period. The secondary beacons are transmitted at varying transmission powers. The processor further executes instructions stored in the memory to extract a value of transmission power from identifier data associated with each of the secondary beacons. The processor further executes instructions stored in the memory to determine, for each of the secondary beacons, an average distance between the mobile device and the beacon device based the value of transmission power. The processor executes instructions stored in the memory to identify an optimal value of transmission power from different values of transmission power based on the average distance and a power lookup table. The processor further executes instructions stored in the memory to compute an actual distance between the mobile device and the beacon device based on the optimal value of transmission power.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for determining a location of a mobile device, in accordance with an embodiment of the present subject matter.

FIG. 2 illustrates detailed workings of the system, in according with an embodiment of the present subject matter.

FIG. 3 illustrates a method for determining a distance between a mobile device and a beacon device, in accordance with an embodiment of the present subject matter.

### DETAILED DESCRIPTION

The present systems and methods will now be described more fully hereinafter with reference to the accompanying drawings in which exemplary embodiments of the disclosure are shown. However, the disclosure may be embodied in many different forms and should not be construed as limited to the representative embodiments set forth herein. The exemplary embodiments are provided so that this disclosure will be both thorough and complete, and will fully convey the scope of the disclosure and enable one of ordinary skill in the art to make, use and practice the disclosure. Like reference numbers refer to like elements throughout the various drawings.

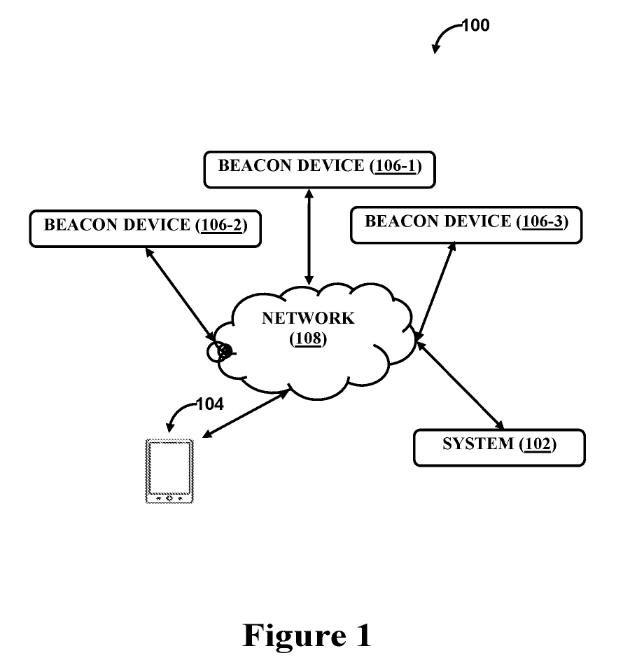

Referring to FIG. 1, a network implementation 100 of a system 102 for determining location of a mobile device 104 is described. The system 102 may be a computing system such as a personal computer, a server, a mainframe computer, a super computer, and the like. In an implementation, the system 102 may be a standalone system. In another implementation, the system 102 may be embedded within the mobile device 104. Such a mobile device, in its entirety, is covered under the scope of the present subject matter. For the sake of clarity and better understanding, the present subject matter is described assuming that the system 102 is a functional part of the mobile device 104. The mobile device 104, in an example, may be a smartphone, a tablet, a PDA device, a phablet device, virtual reality headset device, smart eye wear device, smart watch device or similar wearable smart device and the like.

In an embodiment, the system 102 may receive primary beacons and secondary beacons from one or more beacon devices, individually referred to as a beacon device 106-1, a beacon device 106-2, and a beacon device 106-3 and collectively referred to as beacon devices 106. In an implementation, the system 102 may transmit an initiation request to a beacon device on determining that the mobile device 104 is in a vicinity of the beacon device. In an implementation, the system 102 may discover one or more of the beacon devices 106 in the vicinity of the mobile device 104 by running a Bluetooth Low Energy (BLE) scan.

The system 102, in an implementation, may receive the primary and secondary beacons from the beacon devices 106 over a network 108. The network 108 may be a wireless network, a wired network or a combination thereof. The network 108 can be implemented as one of the different types of networks, such as intranet, local area network (LAN), wide area network (WAN), the internet, and the like. The network 108 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 108 may include a variety of network devices, including routers, bridges, servers, computing devices, storage devices, and the like.

In an implementation, the primary beacons may include advertisement beacons well known in the art. In one example, the primary beacons may be iBeacon®, Eddystone®, Altbeacon®, and the like. In an example, the primary beacons may be transmitted to the mobile device 104 for pushing context based advertisements such as product information, deals, flash sales, and the like to the mobile device 104. In another example, the primary beacons may be used for receiving digital contactless payments from the mobile device 104.

In one embodiment, the secondary beacons may be unique beacons transmitted in regular intervals between transmissions of primary beacons. For instance, the primary beacons may be received by the mobile device 104 in a fixed interval of 100 ms. The secondary beacons, in such an instance, may be received as burst signals every 10 ms or 20 ms. The secondary beacons may be received in bursts so as to ensure that the mobile device 104 receives multiple beacons in a short period of time to allow the system 102 to make accurate calculations of distance. In another embodiment, the secondary beacons may be received at varying transmission powers. Transmitting the secondary beacons at varying transmission powers may again ensure that a most optimal transmission power may be selected for distance estimation. The optimal transmission power, along with value of available signal strength (RSSI) may further aid in better distance estimation. In an implementation, the secondary beacons may be transmitted in conjunction with the primary beacons such that an application running on the mobile device 102 may recognize the secondary beacons. Further, the system 102 may block the secondary beacons in case that a battery percentage of the mobile device is lower than a predefined battery percentage.

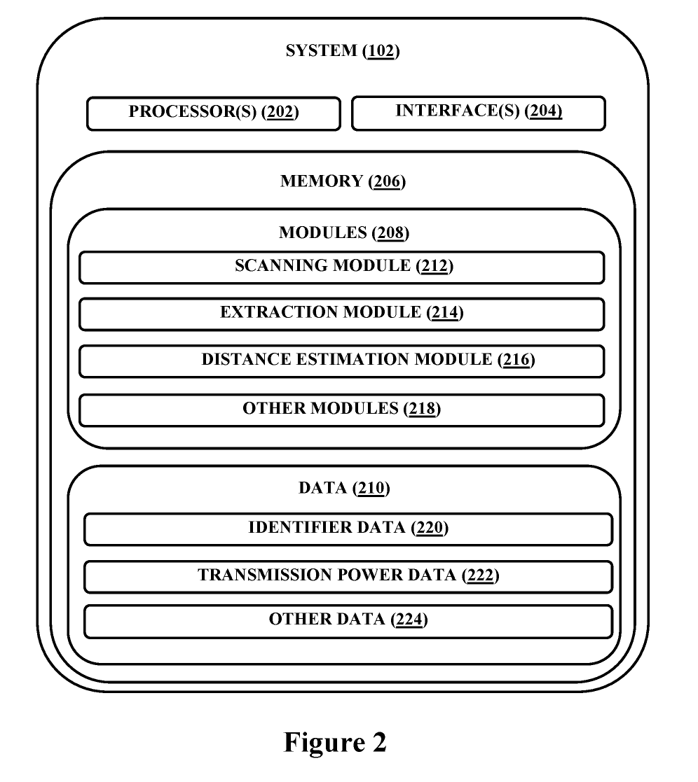

In another embodiment, the system 102 may utilize identifier data extracted from each of the secondary beacons to determine the location of the mobile device 102. The identifier data for a secondary beacon may at least include value of transmission power for the secondary beacon. The system 102, for each secondary beacon, may calculate a weighted average distance between the mobile device and one or more of the plurality of beacon devices 106, based on the value of transmission powers for the secondary beacons. This weighted average distance may be used to identify an optimal transmission power value for the mobile device 104. Based on the optimal transmission power value and a power lookup table, the system 102 may determine the location of the mobile device 104. The detailed workings of the system 102 are described in conjunction with FIG. 2.

FIG. 2 illustrates the system 102 in detail, in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, FPGAs, PLDs and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or nonvolatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 210.

The modules 208 include routines, programs, objects, components, data structures, etc., which perform particular tasks or implement particular abstract data types. In one implementation, the modules 208 may include a scanning module 212, an extraction module 214, a distance estimation module (DEM) 216, and other modules 218.

The data 210, amongst other things, serves as a repository for storing data processed, received, and generated by one or more of the modules 208. The data 210 may also include identifier data 220, transmission power data 222 and other data 224. Other data 224 may be generated as a result of execution of one or more of other modules 218.

In operation, a mobile device implementing the system 102 may query for a location using a Wi-Fi or backhaul network in an indoor location, such as malls. Based on the query, the scanning module 212 may transmit an initiation request from the mobile device to a cloud network or Wi-Fi access point controlling one or more beacon devices in the vicinity of the mobile device. In an exemplary implementation, the initiation request may take a form of a Bluetooth Low Energy (BLE) scan, to identify one or more beacon devices in the vicinity.

Once the one or more beacon devices receive the initiation request, these beacon devices may start transmitting primary beacons and secondary beacons to the mobile device. As described in the foregoing, the primary beacons may be standard advertising beacons such as iBeacon®. The primary beacons may be pushed to the mobile device in order to provide a user context based advertisements. The secondary beacons, in an embodiment, may be transmitted by the one or more beacon devices for aiding in location detection of the mobile device.

In an embodiment, the primary beacons and the secondary beacons may be received by the system 102, alternatively for a predefined time interval. For example, the primary beacons may be received by the system 102 every 100 ms. The secondary beacons may then be received as burst signals, every 10 ms or 20 ms. Further, the secondary beacons may be transmitted at varying transmission powers. For example, the transmission power may start for a low value of −30 dBm and increase up to a value of 4 dBm. The transmission power may vary based on a round robin fashion. The transmission power sequence, in one implementation, may be randomly defined or dynamically set by an access point or gateway and customized for a particular mobile device.

In an implementation, the primary beacons and the secondary beacons may be received by the extraction module 214. The extraction module 214 may extract identifier data from the primary beacons and the secondary beacons. In an embodiment, identifier data from the secondary beacons may be utilized to detect location of the mobile device. The identifier data, in one example, may include authorization tags, beacon names, sequence numbers, mobile device ID, value of transmission power, direction identifiers, mobile identifiers, group identifiers, timestamps, and the like associated with the secondary beacons. The identifier data for the primary beacons may also contain similar information.

Based on the extracted identifier data, the DEM 216 may group the secondary beacons based on value of transmission powers used to transmit the secondary beacons. In an example, such a grouping may be stored in the system 102 as transmission power data 222. In an embodiment, the DEM 216 may query the grouping of secondary beacons with respect to their respective transmission powers, in a loop. Based on the query, the DEM 216 may compute an average distance of the mobile device from the one or more beacon devices based on the value of transmission powers of the secondary beacons, available signal strength and number of secondary beacons received. In an example, the average distance may be calculated using a weighted average technique. For example, the weighted average may be calculated based on the below mathematical equation.

Wavg=(D1+D2 . . . +Dn)/Bn

In the above equation, W_{avg} denotes the weighted average distance. Further, D denotes ratio of signal strength to value of transmission power for a secondary beacon. Bn denotes the total number of secondary beacons received.

The DEM 216, in one embodiment, may identify an optimal value transmission power from the different values of transmission power at which the secondary beacons were transmitted. In an exemplary implementation, the DEM 216 may identify an optimal value of the transmission power based on the average distance of the mobile device and a power lookup table. The power lookup table, in an example, may be generated based on factors such as noise induced by one or more neighboring devices adjacent to the mobile device or obstructions to transmission developed due to one or more objects such as walls, people, kiosks, and the like. The power lookup table, in one exemplary implementation, may be created for each of the secondary beacons during manufacturing stage based on several experimentations.

Based on the optimal value of transmission power, an actual distance of the mobile device from each of the one or more beacon devices may be computed. The actual distance may be computed based on secondary beacons that were transmitted using the optimal value of transmission. Other secondary beacons may be dropped from the calculations. In an example, the actual distance may be calculated as below:

FD=OptimalTxPower/AvgRSSI

Wherein, F_{D} denotes the actual distance, OptimalTxPower denotes the optimal value of transmission power and AvgRSSI denotes average signal strength.

In an implementation, the actual distance of the mobile device from the one or more beacon devices may be used to detect the current location of the mobile device. In an embodiment, the actual distance may be triangulated to determine the current location of the mobile device accurately. In another embodiment, the actual distance may undergo trilateration for determining the current location of the mobile device. Once the current location of the mobile device is determined, the scanning module 212 may transmit a termination request to the one or more beacon devices.

To explain the foregoing by taking an example, the actual distance may be estimated using a ratio between the signal strength (RSSI) and the extracted value of transmission power for each secondary beacon received. For instance, if a secondary beacon is transmitted with a transmission power of 0 dBm transmit power with a measured transmission power at 1 meter distance being −59 dBm and the system 102 receives the secondary beacon with an RSSI of −59 dBm then the distance from the mobile device and the beacon device transmitting the secondary beacon is estimated to be approximately 1 meter.

In an embodiment, the scanning module 212 may block reception of the secondary beacons when a confidence level associated with the primary beacons is higher than a predefined value. In such instances, the primary beacons may be utilized by the system 102 to determine location of the mobile device. For example, a confidence level for a location estimation by trilateration could be a value from 0.0 to 1.0 calculated based on the comparison between the theoretical and practical results for a given set of beacons' distances and their respective physical locations. As the practical results arrive closer to the theoretical estimates the value of confidence level approaches 1.0. In this context, if the confidence level for the primary beacon based trilateration is high then the secondary beacons may not be needed for further correction of the estimation.

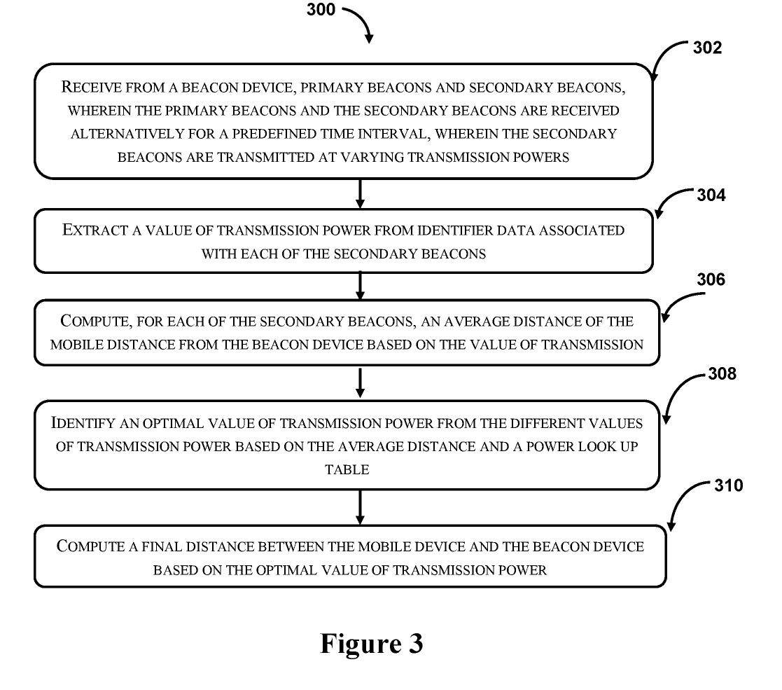

Referring to FIG. 3, a method for determining a distance between a mobile device and a beacon device is illustrated. The method starts at step 302, wherein primary beacons and secondary beacons may be received from the beacon device are received by the mobile device. The primary beacons and the secondary beacons may be alternatively received at predefined time intervals. In an example, the primary beacons may be standard beacons transmitted to the mobile device in order to push different information such as advertisements, to the mobile device. The secondary beacons, in an embodiment may be transmitted to the mobile device at varying transmission powers. The secondary beacons may be transmitted as burst signals between the primary beacons.

At step 304, a value of transmission power associated with each of the secondary beacons may be extracted from an identifier data associated with the secondary beacons. The identifier data, in an example, may also comprise sequence identifier, direction identifier, authentication tags, mobile identifier, group identifier, time and date stamp associated with the secondary beacons.

At step 306, an average distance of the mobile device from the beacon device may be determined for each of the secondary beacon. In an implementation, the average distance may be calculated based on the value of transmission power, available signal strength, and the number of secondary beacons received. The average distance, in an example, may be a weighted average.

At step 308, an optimal value of transmission power from the different values of transmission powers may be identified. The optimal value of transmission power, in an example, may be identified based on the average distance a power lookup table. In an example, the power lookup table may be generated based on factors such as noise induced by one or more adjacent devices adjacent to the mobile device or obstructions to transmission developed due to one or more objects such as walls, people, kiosks, and the like. The power lookup table, in one exemplary implementation, may be created for each of the secondary beacons during manufacturing stage.

At step 310, an actual distance of the mobile distance from the beacon device may be calculated. In an implementation, the actual distance may be used for determining the current location of the mobile device using techniques such as triangulation or trilateration.

Although implementations for methods and systems for enabling a maintenance activity of an equipment have been described in language specific to structural features and/or methods, it is to be understood that the appended claims are not necessarily limited to the specific features or methods described. Rather, the specific features and methods are disclosed as examples of implementations for performing a maintenance activity on an equipment.

We claim:

1. A method for determining distance between a mobile device and a beacon device, the method comprising:
receiving, by a processor, from the beacon device, primary beacons and secondary beacons, wherein the primary beacons and the secondary beacons are received alternatively for a predefined time interval, wherein the secondary beacons are transmitted at varying transmission powers;
extracting, by the processor, a value of transmission power from identifier data associated with each of the secondary beacons;
computing, by the processor, for each of the secondary beacons, an average distance of the mobile device from the beacon device based on the value of transmission power;
identifying, by the processor, an optimal value of transmission power from the different values of transmission power based on the average distance and a power look up table; and
computing, by the processor, an actual distance between the mobile device and the beacon device based on the optimal value of transmission power.

2. The method of claim 1, further comprising grouping, by the processor, the secondary beacons based on the value of transmission power extracted from the secondary beacons.

3. The method of claim 1, further comprising computing, by the processor, the power look up table based on at least one of a) noise induced by one or more adjacent devices or b) obstructions to transmission developed due to one or more objects or people in the vicinity of the mobile device.

4. The method of claim 1, further comprising blocking, by the processor, the plurality of secondary beacons if a remaining battery of the mobile device is below a threshold battery value.

5. The method of claim 1, further comprising:
sending, by the processor, to the beacon device, an initiation request for transmission of the plurality of secondary beacons; and
sending, by the processor, to the beacon device, a termination request when a threshold period of time is elapsed.

6. The method of claim 1, wherein the identifier data further comprises sequence identifier, direction identifier, authentication tags, mobile identifier, group identifier, time and date stamp associated with a secondary beacon.

7. The method of claim 1, wherein the location of the mobile device is determined using one of a triangulation method and a trilateration method.

8. The method of claim 1, wherein the location of the mobile device is determined using the plurality of primary beacons when a confidence level associated with the plurality of primary beacons is higher than a predefined value.

9. A system for determining a distance between a mobile device and a beacon device, the system comprising:
a memory; and
a processor coupled to the memory, wherein the processor executes a set of instructions stored in the memory to:
receive from the beacon device, primary beacons and secondary beacons, wherein the primary beacons and the secondary beacons are received alternatively for a predefined time interval, wherein the secondary beacons are transmitted at varying transmission powers;
extract a value of transmission power from identifier data associated with each of the secondary beacons;
computing, by the processor, for each of the secondary beacons, an average distance of the mobile device from the beacon device based on the value of transmission power;
identify an optimal value of transmission power from the different values of transmission power based on the average distance and a power look up table; and
compute an actual distance between the mobile device and the beacon device based on the optimal value of transmission power.

10. The system of claim 9, wherein the processor is further configured to execute the instructions stored in the memory to group the secondary beacons based on the value of transmission power extracted from the secondary beacons.

11. The system of claim 9, wherein the processor is further configured to execute the instructions stored in the memory to:
send to the beacon device, an initiation request for transmission of the plurality of secondary beacons; and
send to the beacon device, a termination request when a threshold period of time is elapsed.

12. The system of claim 9, wherein the processor is further configured to execute the instructions stored in the memory to determine location of the mobile device using the plurality of primary beacons when a confidence level associated with the plurality of primary beacons is higher than a predefined value.
